(19) United States
(12) Patent Application Publication
(10) Pub. No.: US 2007/0166474 A1
(43) Pub. Date: Jul. 19, 2007

(54) Inkjet recording medium and method for manufacturing the same

(75) Inventors: Ryoichi Nakano, Shizuoka-ken (JP); Kozo Nagata, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/649,821

(22) Filed: Jan. 5, 2007

(30) Foreign Application Priority Data
Jan. 13, 2006 (JP) 2006-006620

(51) Int. Cl. B05D 7/00

(52) U.S. Cl. 427/407.1

(57) ABSTRACT

A method for manufacturing an inkjet recording medium including at least inline-mixing an ink receiving layer forming liquid containing inorganic fine particles and a water-soluble binder and a mordant mixture solution containing a basic poly aluminum hydroxide compound and a cationic polymer to form a coating liquid; and applying the coating liquid onto a support to form a coated layer and an inkjet recording medium manufactured by the manufacturing method.

### CROSS-REFERENCE TO RELATED APPLICATION

This application claims priority under 35 USC 119 from Japanese Patent Application No. 2006-006620, the disclosure of which is incorporated by reference herein.

### BACKGROUND OF THE INVENTION

1. Field of the Invention

The present invention relates to an inkjet recording medium, which is a recording medium suitably used for inkjet recording method, and a method for manufacturing the same.

2. Description of the Related Art

In recent years, a variety of information processing systems such as an inkjet recording method, a thermal recording method, a pressure sensitive recording method, a photosensitive recording method, and a transfer-type recording method have been developed with rapid advancements in information-technology industry; and recording methods and recording instruments suitable for these information processing systems have also been developed and put into practical use.

Among others, the inkjet recording method has been used widely in home use in addition to office use as a matter of course, in view of such advantages as capability of recording on a variety of recording materials, relatively inexpensive and compact hardware (apparatus), and excellent quietness.

With an increase in resolution of inkjet printers in recent years, it has become possible to obtain a high-quality recorded material, a so-called photo-like recorded material. A variety of recording sheets for inkjet recording have been developed also with such progress of hardware (apparatuses) as mentioned above.

Characteristics required for a recording medium for inkjet recording include commonly (1) quick-drying (high ink absorption rate), (2) adequate and uniform diameter of ink dots (no bleeding), (3) good graininess, (4) high circularity of dots, (5) high color concentration, (6) high color saturation (dullness-free), (7) excellent water resistance, light resistance, and ozone resistance of a printed area, (8) high whiteness of a recording sheet, (9) good storability of the recording sheet (no yellowing or discoloration even in long storage), and no bleeding in the image even during long storage (excellent suppression of bleed over time), (10) resistance to deformation and good dimensional stability (sufficiently small curl), and (11) good traveling performance in hardware.

In an application for photographic glossy paper which is used for the purpose of obtaining a so-called photo-like high-quality recording product, it is required for the paper to have glossiness, glossiness of printed area, surface smoothness, photographic paper-like feeling similar to silver salt photography, and the like, in addition to the above-described various characteristics.

For the purpose of improving the above-described various characteristics, an inkjet recording medium in which the recording layer (ink receiving layer) has a porous structure has been developed and put into practical use in recent years. Since such an inkjet recording medium involves the porous structure, the recording medium is excellent in ink receiving property (quick-drying) and has high glossiness.

For instance, an inkjet recording medium has been proposed which has, on a support, a recording layer having high void fraction and containing fine inorganic pigment particles and a water-soluble binder (see Japanese Patent Application Laid-Open Nos. (JP-A) 10-119423 and 10-217601).

These recording sheets, particularly the inkjet recording medium having a recording layer of a porous structure containing silica as the inorganic fine particles, exhibit excellent ink absorbing property owing to the structure thereof, and have high ink receiving performance that enables formation of an image of high resolution and high glossiness.

However, such recording sheets have a problem in that the gas permeability is high due to the porous film, which may accelerate the deterioration of the components contained in the recording layer.

A trace gas in the air, particularly ozone, can be a cause for fading of a recorded image over time. Since the recording materials having a recording layer of the above-mentioned porous structure have a lot of voids, the recorded image is easily faded by ozone in the air. Therefore, resistance to ozone gas (ozone resistance) is a very important characteristic for a recording material having a recording layer of the above-described porous structure.

### SUMMARY OF THE INVENTION

According to research by the present inventors, ozone resistance can be improved by adding a cationic polymer to a recording layer. However, when the cationic polymer is contained in a coating liquid for forming a recording layer together with inorganic fine particles such as silica, there are cases where viscosity of the coating liquid increases, presenting obstacles with respect to handling of the coating liquid.

The present invention has been made in view of the above-described situation. According to the present invention, there is provided a method for manufacturing an inkjet recording medium, which is capable of suppressing an increase in the viscosity of the coating liquid, as well as an inkjet recording medium manufactured by the method, which has excellent ozone resistance.

According to an aspect of the invention, there is provided a method for manufacturing an inkjet recording medium including at least inline-mixing an ink receiving layer forming liquid containing inorganic fine particles and a water-soluble binder and a mordant mixture solution containing a basic poly aluminum hydroxide compound and a cationic polymer to form a coating liquid; and applying the coating liquid onto a support to form a coated layer.

According to another aspect of the invention, there is provided an inkjet recording medium manufactured by the method for manufacturing an inkjet recording medium according to an aspect of the invention.

### DETAILED DESCRIPTION OF THE INVENTION

In the following, the inkjet recording medium and the method for manufacturing thereof according to the present invention will be described in detail.

The method for manufacturing an inkjet recording medium according to the present invention includes at least inline-mixing an ink receiving layer forming liquid containing inorganic fine particles and a water-soluble binder and a mordant mixture solution containing a basic poly aluminum hydroxide and a cationic polymer to form a coating liquid; and applying the coating liquid onto a support to form a coated layer.

When the cationic polymer and the inorganic fine particles are present together, there are cases where viscosity of the coating liquid increases, whereby handling properties of the coating liquid deteriorate. According to the method for manufacturing an inkjet recording medium of the present invention, since an ink receiving layer forming liquid containing inorganic fine particles and a mordant mixture solution containing a cationic polymer are inline-mixed and then coated, it is possible to shorten the time period that the inorganic fine particles and the cationic polymer are present together. As a result, it is possible to suppress an increase in the viscosity of the coating liquid.

When preparing the coating liquid, a known inline-mixing apparatus can be preferably used for mixing the two kinds of liquids. An inline-mixing apparatus described in JP-A No. 2002-85948 or the like may be preferably used in the present invention.

The inkjet recording medium of the present invention is manufactured by the method for manufacturing an inkjet recording medium according to the present invention. The inkjet recording medium of the present invention has excellent ozone resistance.

The materials used for the manufacturing method of the ink jet recording medium of the present invention will be described below.

### Inorganic Fine Particles

Examples of the inorganic fine particles include silica fine particles, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide, and yttrium oxide. Silica fine particles, colloidal silica, alumina fine particles and pseudo-boehmite are preferable among them from the viewpoint of forming a good porous structure. The fine particles may be used as primary particles, or after forming secondary particles. The average primary particle diameter of these fine particles is preferably 2 μm or less, more preferably 200 nm or less.

Furthermore, silica fine particles with an average primary particle diameter of 20 nm or less, colloidal silica with an average primary particle diameter of 30 nm or less, alumina fine particles with an average primary particle diameter of 20 nm or less, and pseudo-boehmite with an average fine pore diameter of 2 to 15 nm are more preferable, and the silica fine particles, alumina fine particles and pseudo-boehmite are particularly preferable.

The silica fine particles are roughly classified into wet method particles and dry method (gas phase method) particles depending on their production method. In a typical example of the wet method, active silica is formed by acidolysis of a silicate salt, and active silica is polymerized to an adequate degree, and then is coagulated and precipitated to form hydrated silica. In contrast, in a typical example of the gas phase method, anhydrous silica is obtained by hydrolysis of silicon halide in gas phase at high temperature (flame hydrolysis method), or silica sand and coke are vaporized by reduction by heating with arc in an electric furnace, and the product thereof is oxidized with air (arc method). The “gas phase silica” means anhydrous silica fine particles obtained by the gas phase method. The gas phase silica fine particles are particularly preferable as the silica fine particles used in the invention.

Although the gas phase silica exhibits different properties from hydrated silica due to the difference in the density of the silanol groups on the surface and in the proportion of the voids, the gas phase silica is suitable for forming a three-dimensional structure having a high void ratio. While the reason thereof is not clear, the density of the silanol groups on the surface of the fine particles is as large as 5 to 8 groups/nm² in the case of hydrated silica, and thus the silica fine particles easily aggregate. In contrast, the density of the silanol group on the surface of the fine particles is as small as 2 to 3 groups/nm² in the case of gas phase silica, and thus the fine particles form coarse and soft aggregate (flocculate), thereby forming a structure having a high void ratio.

Since gas phase silica has a particularly large surface area, the efficiency for absorbing and retaining ink is high. In addition, owing to a low refractive index of gas phase silica, transparency can be rendered to the ink receiving layer by dispersing the particles to an adequate particle diameter, whereby high color density and good coloring property can be obtained. The transparency of the receiving layer is important for obtaining a high color density and good glossiness of colors, not only in the uses requiring high transparency such as an OHP film, but also in an application as a recording sheet such as a photographic glossy paper.

The average primary particle diameter of the inorganic fine particles (e.g., gas phase silica) is preferably 50 nm or less, more preferably from 3 to 50 nm, still more preferably from 3 to 30 nm, particularly preferably 3 to 20 nm, and most preferably 3 to 10 nm, in view of the quick drying property (ink absorption rate). Since the gas phase silica particles are liable to be coagulated with each other due to hydrogen bonds between the silanol groups, a structure having a large void ratio can be formed when the average primary particle diameter is 50 nm or less, and ink absorbing characteristics can be effectively improved.

The gas phase silica may be used together with other inorganic fine particles such as those described above. The content of gas phase silica is preferably 30 mass % or more, more preferably 50 mass % or more, when the gas phase silica is used together with other fine particles.

Alumina fine particles, alumina hydrate, and a mixture or composite thereof are also preferable as the inorganic fine particles used in the invention. The alumina hydrate is preferable among them since it absorbs ink well and fixes the ink, and pseudo-boehmite (Al₂O₃.nH₂O) is particularly preferable. While various forms of the alumina hydrate may be used, boehmite sol is preferably used as the raw material since a smooth layer can be readily obtained.

The fine void structure of pseudo-boehmite preferably has an average fine void diameter of 1 to 30 nm, more preferably 2 to 15 nm. The fine void volume is preferably 0.3 to 2.0 cc/g, more preferably 0.5 to 1.5 cc/g. The fine void diameter and fine void volume are measured by a nitrogen absorption-desorption method using, for example, a gas absorption-desorption analyzer (for example, OMNISORP 369 manufactured by Beckman Coulter, Inc.).

The gas phase alumina fine particles are preferable among the alumna fine particles due to their large surface area. The average primary particle diameter of the gas phase alumina is preferably 30 nm or less, more preferably 20 nm or less.

When the fine particles are used in the inkjet recording medium, for example, embodiments disclosed in JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777 and 2001-301314 can also be used preferably.

### Water-Soluble Binder

Examples of the water-soluble binder used in the ink receiving layer include polyvinyl alcohol resins (e.g., polyvinyl alcohol (PVA), acetoacetyl-modified polyvinyl alcohol, cation-modified polyvinyl alcohol, anion-modified polyvinyl alcohol, silanol-modified polyvinyl alcohol and polyvinyl acetal), which are resins having hydroxyl groups as hydrophilic structural units, cellulose resins (methyl cellulose (MC), ethyl cellulose (EC), hydroxyethyl cellulose (HEC), carboxymethyl cellulose (CMC), hydroxypropyl cellulose (HPC), hydroxyethylmethyl cellulose and hydroxypropylmethyl cellulose), chitins, chitosans, starches, resins having ether bonds (polyethylene oxide (PEO), polypropylene oxide (PPO), polyethyleneglycol (PEG) and polyvinyl ether (PVE)), and resins having carbamoyl groups (polyacrylamide (PAAM), polyvinyl pyrrolidone (PVP) and polyacrylic acid hydrazide).

Other examples include polyacrylic acid salts, maleic acid resins, alginic acid salts and gelatins, having carboxylic groups as dissociation groups.

The polyvinyl alcohol resins are particularly preferable among the resin above. Examples of the polyvinyl alcohol resins are described in Japanese Patent Application Publication (JP-B) Nos. 4-52786, 5-67432 and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, JP-A Nos. 2000-158801, 2001-213045, 2001-328345, 8-324105, and 11-348417.

Examples of water-soluble binders other than polyvinyl alcohol resins include the compounds described in paragraph [0011] to [0014] in JP-A No. 11-165461.

Only one water-soluble binder may be used, or a combination of two or more water-soluble binders may be used.

The content of the water-soluble binder of the invention is preferably 9 to 40 mass %, more preferably 12 to 33 mass %, relative to the mass of the total solid content of the ink receiving layer.

The water-soluble binder and the inorganic fine particles, which are main constituents of the ink receiving layer according to the invention, each may be composed of a single material, or a mixture of plural materials.

The kind of the water-soluble binder to be combined with the inorganic fine particles, particularly silica fine particles, is important from the viewpoint of maintaining transparency. When gas phase silica is used, the water-soluble binder is preferably a polyvinyl alcohol resin. In particular, the polyvinyl alcohol resin preferably has a saponification degree of 70 to 100%, more preferably 80 to 99.5%.

While the polyvinyl alcohol resin has hydroxyl groups in its structural units, a three dimensional network structure with secondary particles of the silica fine particles as network chain units is readily formed since hydrogen bonds are formed between the hydroxyl groups and the silanol groups on the surface of the silica fine particles. It is considered that an ink receiving layer having a porous structure with a high void ratio and sufficient strength is formed owing to the formation of the three dimensional network structure.

The porous ink receiving layer obtained as described above rapidly absorbs ink by capillary action during inkjet recording, and thus dots of good circularity can be formed without ink bleed.

The polyvinyl alcohol resin may be used together with other water-soluble binders. The content of polyvinyl alcohol resin in the total water-soluble binders is preferably 50 mass % or more, more preferably 70 mass % or more, when the polyvinyl alcohol resin is used together with other water-soluble binders. Composition Ratio between Inorganic Fine Particles and Water-Soluble Binder The mass composition ratio (PB ratio (x/y)) of inorganic fine particles (x) to water-soluble binder (y) largely affects the structure and strength of the ink receiving layer. While the void ratio, fine void volume and surface area (per unit mass) increase as the mass composition ratio (PB ratio) increases, the density and strength tend to be lowered.

The mass composition ratio (PB ratio, (x/y)) in the ink receiving layer of the invention is preferably in the range of 1.5 to 10, so as to prevent decrease in the layer strength and generation of cracks at drying resulting from an excessively large PB ratio, and so as to prevent decrease in ink absorbing property accompanying reduction of void ratio caused by easily occurring filling of voids with the resin resulting from an excessively small PB ratio.

Since the recording sheet may suffer stress when conveyed in a conveyer system of an inkjet printer, the ink receiving layer should have sufficient film strength. Sufficient strength of the ink receiving layer is required also for preventing cracks and peeling of the ink receiving layer when the recording sheet is cut into smaller sheets. The mass ratio (x/y) is preferably 5 or less in consideration of the above situation, and is preferably 2 or more from the viewpoint of ensuring high speed ink absorption in the inkjet printer.

A three dimensional network structure with the secondary particles of the silica fine particles as the network chains is formed, for example, by preparing a coating liquid in which gas phase silica fine particles with an average primary diameter of 20 nm or less and a water-soluble binder are completely dispersed in water in a mass ratio (x/y) of 2 to 5, applying the coating liquid onto a support, and then drying the coated layer, whereby a light-transmitting porous layer with an average fine void diameter of 30 nm or less, a void ratio of 50 to 80%, a specific void volume of 0.5 ml/g or more, and a specific surface area of 100 m²/g or more can be readily formed.

### Crosslinking Agent

In the inkjet recording medium according to the invention, the ink receiving layer preferably contains a water-soluble binder. The ink receiving layer is preferably a porous layer obtained by forming the coated layer containing the cationic polymer, the inorganic fine particles, the water-soluble binder and a crosslinking agent capable of crosslinking the water-soluble binder, and curing the coated layer through a crosslinking reaction between the crosslinking agent and the water-soluble binder. In the invention, the crosslinking agent may be contained in at least one of the ink receiving layer forming liquid and the mordant mixture solution.

Boron compounds are preferably used for crosslinking the water-soluble binder, particularly polyvinyl alcohol resin. Examples of the boron compound include borax, boric acid, borate (for example orthoborate, InBO₃, ScBO₃, YBO₃, LaBO₃, Mg₃(BO₃)₂ and Co₃(BO₃)₂), diborate (for example Mg₂B₂O₅, Co₂B₂O₅), methaborate (for example Ca(BO₂)₂, NaBO₂ and KBO₂), tetraborate (for example Na₂B₄O₇.10H₂O), and pentaborate (for example KB₅O₈.4H₂O, Ca₂B₆O₁₁.7H₂O, and CsB₅O₅). Borax, boric acid and borates are preferable since they can cause crosslinking reaction quickly, and boric acid is particularly preferable.

The following compounds other than boron compounds may be used as the crosslinking agent for the water-soluble binder.

Examples of such other crosslinking agents include aldehyde compounds such as formaldehyde, glyoxal and glutaraldehyde; ketone compounds such as diacetyl and cyclopentanedione; active halogen compounds such as bis(2-chloroethylurea), 2-hydroxy-4,6-dichloro-1,3,5-triazine, 2,4-dichloro-6-S-triazine sodium salt; active vinyl compounds such as divinyl sulfonic acid, 1,3-divinylsulfonyl-2-propanol, N,N′-ethylenebis(vinylsulfonylacetamide), and 1,3,5-triaclyroyl-hexahydro-S-triazine; N-methylol compounds such as dimethylol urea and methylol dimethylhydantoin; melamine resins (for example, methylolmelamine, alkylated methylolmelamine); epoxy resins; isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; epoxy compounds such as glycerol triglycidyl ether; ethylene imino compounds such as 1,6-hexamethylene-N,N′-bisethylene urea; halogenated carboxyaldehyde compounds such as mucochloric acid and mucophenoxy chloric acid; dioxane compounds such as 2,3-dihydroxydioxane, metal-containing compounds such as titanium lactate, aluminum sulfate, chromium alum, potassium alum, zirconium acetate and chromium acetate; polyamine compounds such as tetraethylenepentamine; hydrazide compounds such as adipic acid dihydrazide; and low molecular weight compounds or polymers containing at least two oxazoline groups.

Only a single crosslinking agent selected from the above may be used, or two or more crosslinking agents selected from the above may be used in combination.

As mentioned hereunder, crosslink curing is preferably carried out in the following manner: a crosslinking agent is added to a coating liquid containing inorganic fine particles, a water-soluble binder and the like (hereinafter the coating liquid obtained by inline-mixing the ink receiving layer forming liquid and the mordant mixture liquid is occasionally referred to as “first liquid”) and/or to a basic solution having a pH of 7.1 or higher (hereinafter occasionally referred to as “second liquid”); and onto the coated layer formed by application of the first liquid, the second liquid is applied (1) simultaneously with the application of the coating liquid (first liquid) for forming the coated layer, or (2) before the coated layer exhibits a decreasing rate of drying during drying of the coated layer formed by application of the first liquid. Application of the crosslinking agent is preferably conducted as follows when a boron compound is used as an example. Namely, if the ink receiving layer is a layer obtained by crosslink-curing of a coated layer formed by application of the coating liquid (first liquid) containing fine particles and a water-soluble binder containing polyvinyl alcohol, the crosslink curing is carried out by applying the basic solution having a pH of 7.1 or higher (the second liquid) onto the coated layer (1) simultaneously with the application of the first liquid, or (2) before the coated layer exhibits a decreasing rate of drying during drying of the coated layer formed by application of the first liquid. The boron compound as a crosslinking agent may be contained at least one of the first and the second liquids, and may be contained in the both of the liquids.

The amount of crosslinking agent to be used is preferably from 1 to 50 mass %, and more preferably from 5 to 40 mass % relative to the water-soluble binder.

### Basic Poly Aluminum Hydroxide Compound

The main component of the basic poly aluminum hydroxide compound is represented by Al₂(OH)ₙClₘ(m+n=6). Examples of the basic poly aluminum hydroxide compounds include basic polymeric poly aluminum hydroxide compounds stably containing polynuclear condensed ions, such as Al₂(OH)₅Cl₁, Al₂(OH)_{4.5}Cl_{1.5}, Al₂(OH)₄Cl₂.

These compounds are supplied from Taki Chemical Co., Ltd. under the name of poly aluminum chloride (PAC) as a chemical for water treatment, from Asada Chemical Co., Ltd. under the name of poly aluminum hydroxide (Paho), from Riken Green Co., Ltd. under the name of HAP-25, from Taimei Chemicals Co., Ltd. under the name of ALUFINE 83, and from other manufacturers for the same purpose. Products of various grades are easily available.

The ink receiving layer in the invention preferably contains another water-soluble polyvalent metal compound other than the basic poly aluminum hydroxide compound described above.

As the water-soluble polyvalent metal compound used in the invention, trivalent or higher multivalent metal compounds are preferable. The polyvalent metal compound may be, for example, a water-soluble salt of a metal selected from calcium, barium, manganese, copper, cobalt, nickel, aluminum, iron, zinc, zirconium, chromium, magnesium, tungsten, and molybdenum.

Specific examples thereof include calcium acetate, calcium chloride, calcium formate, calcium sulfate, calcium butyrate, barium acetate, barium sulfate, barium phosphate, barium oxalate, barium naphthoresorcin carboxylate, barium butyrate, manganese chloride, manganese acetate, manganese formate dihydrate, ammonium manganese sulfate hexahydrate, cupric chloride, ammonium copper (II) chloride dihydrate, copper sulfate, copper (II) butyrate, copper oxalate, copper phthalate, copper citrate, copper gluconate, copper naphthenate, cobalt chloride, cobalt thiocyanate, cobalt sulfate, cobalt (II) acetate, cobalt naphthenate, nickel sulfate hexahydrate, nickel chloride hexahydrate, nickel acetate tetrahydrate, ammonium nickel sulfate hexahydrate, amide nickel sulfate tetrahydrate, nickel sulfaminate, nickel 2-ethylhexanoate, aluminum sulfate, aluminum sulfite, aluminum thiosulfate, poly aluminum chloride, aluminum nitrate nonahydrate, aluminum chloride hexahydrate, aluminum acetate, aluminum lactate, basic aluminum thioglycolate, ferrous bromide, ferrous chloride, ferric chloride, ferric sulfate, ferrous sulfate, iron (III) citrate, iron (III) lactate trihydrate, triammonium iron (III) trioxalate trihydrate, zinc bromide, zinc chloride, zinc nitrate hexahydrate, zinc sulfate, zinc acetate, zinc lactate, zirconium acetate, zirconium tetrachloride, zirconium chloride, zirconium oxychloride octahydrate, zirconium hydroxychloride, chromium acetate, chromium sulfate, magnesium acetate, magnesium oxalate, magnesium sulfate, magnesium chloride hexahydrate, magnesium citrate nonahydrate, sodium tungstophosphate, tungsten sodium citrate, dodecatungstophosphate n-hydrate, dodecatungstosilicate hexacosahydrate, molybdenum chloride, dodecamolybdophosphate n-hydrate and the like, aluminum alum, zinc phenolsulfonate, ammonium zinc acetate, and ammonium zinc carbonate. Two or more of these water-soluble polyvalent metal compounds may be used together. In the invention, the term “water-soluble” regarding water-soluble polyvalent metal compounds means that the polyvalent metal compounds are dissolves, at a concentration of 1 mass % or more, in water of 20° C.

Among the above-described water-soluble polyvalent metal compounds, an aluminum compound or a compound containing a metal belonging to Group 4A of the Periodic Table (for example, zirconium or titanium) is preferable, and an aluminum compound is more preferable. Particularly preferred is a water-soluble aluminum compound. The water-soluble aluminum compound may be an inorganic salt whose examples are aluminum chloride and hydrates thereof, aluminum sulfate and hydrates thereof, and aluminum alum.

As the water-soluble compound containing an element of Group 4A of the Periodic Table, water-soluble compounds containing titanium or zirconium are more preferable. Examples of a water-soluble compound containing titanium include titanium chloride, titanium sulfate, titanium tetrachloride, tetraisopropyl titanate, titanium acetylacetonate, and titanium lactate. Examples of a water-soluble compound containing zirconium include zirconium acetate, zirconium chloride, zirconium hydroxychloride, zirconium nitrate, basic zirconium carbonate, zirconium hydroxide, zirconium lactate, ammonium zirconium carbonate, potassium zirconium carbonate, zirconium sulfate, and zirconium fluoride compounds.

It is preferred that the total amount of the basic poly aluminum hydroxide compound described above and the water-soluble polyvalent metal compound used as required is 0.1 to 10 mass %, and more preferably 0.5 to 8 mass % with respect to the inorganic fine particles.

### Cationic Polymer

The cationic polymer for use in the invention is not particularly limited, but a cationic polymer having an I/O value of 3 or more is preferable. The I/O value is a value obtained by dividing inorganic groups by organic groups in accordance with the organic conception diagram. Specifically, the I/O value is determined according to the method described in “Yuki Gainenzu—Kiso to Oyo (Basis and Application of Organic Conceptual Diagram)” (Yoshio Koda, Sankyo Publishing Co., 1984).

In the organic conception diagram, the property of a compound is divided into that of organic groups showing covalent-bond character and that of inorganic groups showing ionic-bond character, and various organic compounds are plotted on a rectangular coordinate consisting of so-called organic and inorganic axes. Inorganicity value in the conception diagram means the degree of inorganicity, i.e., a relative degree of the influence of a substituent group on the boiling point of the molecule with respect to 100 of a hydroxyl group, which is based on the fact that the distance between the boiling point curve of straight-chain alcohols and the boiling point curve of straight-chain paraffins is approximately 100° C. when determined at a carbon atom number of around 5. On the other hand, the degree of organicity of a molecule reflects the number of methylene groups, or carbons, present in the molecule, and the organicity value is a relative value thereof with respect to 20 of a methylene group, as the standard value of 20 per methylene group is the average increase of 20° C. when one carbon atom is added to a straight-chain compound having 5 to 10 carbon atoms. The inorganicity and organicity values correspond respectively to the coordinates in the graph. The I/O value was determined from these values.

The cationic polymer according to the present invention preferably has an I/O value of 4 or more. Use of a cationic polymer having an I/O value of 3 or more is effective in improving ozone resistance.

Typical examples of the cationic polymers include the cationic polymers for mordant described below and polyalkylamine epichlorohydrin polycondensates; and polyalkylamine epichlorohydrin polycondensates are preferable for improvement of ozone resistance.

The content of the cationic polymer in the ink receiving layer is preferably 0.01 to 2.0 g/m², more preferably, 0.1 to 1.0 g/m². A cationic polymer content in ink receiving layer of less than 0.01 g/m² may lead to decrease in improvement of ozone resistance, while a content of more than 2.0 g/m² occasionally results in bronzing.

### Mordant

In the invention, it is preferred that the ink receiving layer contains a mordant other than the water-soluble polyvalent metal compound in order to further improve the water resistance and the resistance to bleed over time of a formed image.

The mordant is preferably a cationic polymer (cationic mordant) that is an organic mordant, or an inorganic mordant. When the mordant is contained in the ink receiving layer, the mordant interacts with an anionic dye contained as a colorant in liquid ink to stabilize the colorant, thereby improving the water resistance and the resistance to bleed over time. Organic mordants and inorganic mordants each may be used alone. In an embodiment, one or more organic mordants and one or more inorganic mordants are used in combination.

As the cationic mordant, a polymer mordant having, as a cationic group, a primary, secondary, or tertiary amino group or a quaternary ammonium base is used in general. However, the cationic mordant may be a cationic non-polymer mordant in the invention.

Examples of the polymer mordant include: homopolymers of a monomer (mordant monomer) having a primary, secondary, or tertiary amino group, or a salt thereof, or a quaternary ammonium base; copolymers or condensation polymers of the mordant monomer and one or more other monomers (hereinafter referred to as “non-mordant monomer”). These polymer mordants may be used in the form of a water-soluble polymer or water-dispersible latex particles.

Examples of the monomer (mordant monomer) include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, and N,N-dimethyl-N-phenyl-N-p-vinylbenzylammonium chloride, trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, and N,N-diethyl-N-methyl-N-2-(4-vinylphenyl)ethylammonium acetate, N,N-dimethylaminoethyl(meth)acrylate, N,N-diethylaminoethyl(meth)acrylate, N,N-dimethylaminopropyl(meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(meth)acrylamide, N,N-diethylaminopropyl(meth)acrylamide, and salts thereof (for example, hydrochlorides, nitrates, acetates, lactates, methanesulfonates, p-toluenesulfonates and the like), trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, and trimethyl-3-(acryloylamino)propylammonium acetate.

Examples of other mordant monomer include N-vinylimidazole, N-vinyl-2-methylimidazole, 2-vinylpyridine, 4-vinylpyridine, 4-vinyl-N-methylpyridinium chloride, 4-vinyl-N-ethylpyridinium bromide, dimethyldiallylammonium chloride, and monomethyldiallylammonium chloride.

Only one of such mordant monomers may be used, or two or more copolymerizable mordant monomers may be used in combination.

The non-mordant monomer refers to a monomer which does contain a basic or cationic portion such as a primary, secondary, or tertiary amino group or a quaternary ammonium salt, and which does not interact, or exhibit substantially small interaction, with the dye in ink-jet ink.

Examples of the non-mordant monomer include alkyl (meth)acrylates (for example an ester between C1-18 alkyl and (meth)acrylatic acid, such as methyl (meth)acrylate, ethyl (meth)acrylate, propyl(meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate and stearyl (meth)acrylate); cycloalkyl (meth)acrylates (such as cyclohexyl (meth)acrylate); aryl (meth)acrylates (such as phenyl (meth)acrylate)); aralkyl esters (such as benzyl(meth)acrylate); substituted alkyl (meth)acrylates (such as 2-hydroxyethyl (meth)acrylate, methoxymethyl (meth)acrylate and allyl (meth)acrylate); (meth)acrylamides (such as (meth)acrylamide, dimethyl (meth)acrylamide, N-ethyl (meth)acrylamide, and N-isopropyl (meth)acrylamide); aromatic vinyls (styrene, vinyltoluene and α-methylstyrene); vinyl esters (such as vinyl acetate, vinyl propionate and vinyl versatate); allyl esters (such as allyl acetate); halogen-containing monomers (such as vinylidene chloride and vinyl chloride); vinyl cyanates (such as (meth)acrylonitrile); and olefins (such as ethylene and propylene).

Only one non-mordant monomer may be used, or two or more non-mordant monomers may be used in combination.

Examples of the polymer mordant include polyethyleneimine (and derivatives thereof), polyvinylamine (and derivatives thereof), polyallyamine (and derivatives thereof), polyamidine, cationic polysaccharides (such as cationic starch and chitosan), dicyan cationic resins (such as dicyan diamide-formalin polycondensate), polyamine cationic resins (such as dicyan diamide-diethylenetriamine polycondensate), epichlorohydrin-dimethylamine addition polymers, and dimethyldiallylammonium chloride-sulfur dioxide copolymer.

Polymers having a quaternary ammonium base are preferable, and (meth)acrylate polymers, vinylbenzylammonium polymers and diallylammonium polymers having weight average molecular weight of 1,000 to 100,000 and having a quaternary ammonium base are particularly preferable as the organic mordant in the invention.

In the invention, the content of the mordant in the ink receiving layer is preferably from 0.01 to 10 g/m², more preferably from 0.1 to 5 g/m².

At least one of the ink receiving layer forming liquid and the mordant mixture solution may further include a water-dispersible latex. Specific examples of the water-dispersible latex include a cation-modified resin latex, an anion-modified resin latex, and a resin latex which does not have a charge. Among these, a cation-modified resin latex is preferable, and a cation-modified urethane latex is more preferable. In the present invention, the content of the water-dispersible latex contained in the ink receiving layer is preferably 0.1 to 3.0 g/m², and more preferably 0.1 to 1.5 g/m². When the content of the water-dispersible latex is 0.1 to 3.0 g/m², the effect of suppressing bleeding is great, and ozone resistance is also improved. When the content of the water-dispersible latex is more than 3.0 g/m², the ink absorption amount may decrease.

The mordant mixture liquid preferably contains a surfactant. As the surfactant, cationic surfactants, anionic surfactants, nonionic surfactants, amphoteric surfactants, fluorosurfactants, and silicone surfactants are all usable.

Examples of preferable nonionic surfactants include polyoxyalkylene alkylethers and polyoxyalkylene alkylphenylethers (such as diethyleneglycol monoethylether, diethyleneglycol diethylether, polyoxyethylene laurylether, polyoxyethylene stearylether and polyoxyethylene nonylphenylether); oxyethylene-oxypropylene block copolymers, sorbitan fatty acid esters (such as sorbitan monolaurate, sorbitan monooleate and sorbitan trioleate); polyoxyethylene sorbitan fatty acid esters (such as polyoxyethylene sorbitan monolaurate, polyoxyethylene sorbitan monoolelate and polyoxyethylene sorbitan trioleate); polyoxyethylene sorbitol fatty acid esters (such as tetra oleic acid polyoxyethylene sorbit); glycerin fatty acid esters (such as glycerol monooleate); polyoxyethylene glycerin fatty acid esters (such as monostearic acid polyoxyethylene glycerin and monooleic acid polyoxyethylene glycerin); polyoxyethylene fatty acid esters (such as polyethyleneglycol monolaurate, and polyethyleneglycol monooleate); polyoxyethylene alkylamines; and acetylene glycols (such as 2,4,7,9-tetramethyl-5-decyn-4,7-diol, and ethylene oxide adducts and propylene oxide adducts of the diol). Polyoxyalkylene alkylethers are preferable among them. The nonionic surfactant may be used in the first solution and the second solution. Only one nonionic surfactant may be used, or two or more nonionic surfactants may be used in combination.

Examples of amphoteric surfactants include amino acid type amphoteric surfactants, betaine type amphoteric surfactants such as carboxyamonium betaine type, sulfonammonium betaine type, ammonium sulfonic ester betaine type and imidazolium betaine type, and those described in U.S. Pat. No. 3,843,368, JP-A Nos. 59-49535, 63-236546, 5-303205, 8-262742 and 10-282619 may be favorably used. The amphoteric surfactant may be an amphoteric surfactant of amino acid type, which may be derived from an amino acid (such as glycine, glutamic acid or histidine) as described in JP-A No. 5-303205. Specifically, the amphoteric surfactant may be an N-aminoacyl acid having a long chain acyl group introduced thereto, or a salt thereof Only a single amphoteric surfactant may be used, or two or more amphoteric surfactants may be used in combination.

Examples of anionic surfactants include fatty acid salts (for example, sodium stearate and potassium oleate), salts of alkylsulfuric acid esters (for example, sodium lauryl sulfate and triethanolamine lauryl sulfate), sulfonic acid salts (for example, sodium dodecylbenzene sulfonate), alkylsulfosuccinic acid salts (for example, sodium dioctylsulfosuccinate), alkyldiphenylether disulfonic acid salts, and alkylphosphoric acid salts.

Examples of cationic surfactants include alkylamine salts, quaternary ammonium salts, pyridinium salts and imidazolium salts.

Examples of fluorosurfactants include a compound derived from an intermediate having a perfluoroalkyl group using a method such as electrolytic fluorination, telomerization, or origomerization.

Examples of fluorosurfactants include perfluoroalkyl sulfonic acid salts, perfluoroalkyl carboxylic acid salts, perfluoroalkyl ethylene oxide adducts, perfluoroalkyl trialkyl ammonium salts, perfluoroalkyl group-containing oligomers, and perfluoroalkyl phosphoric acid esters.

The silicon surfactant is preferably a silicone oil modified with an organic group, which may have a structure in which a side chain of a siloxane structure is modified with the organic group, a structure in which the both terminals of a siloxane structure are modified with the organic group, or a structure in which one of the terminals of a siloxane structure is modified with the organic group. Examples of modification with the organic group include amino modification, polyether modification, epoxy modification, carboxyl modification, carbinol modification, alkyl modification, aralkyl modification, phenol modification and fluorine modification.

In the invention, the content of the surfactant is preferably 0.001 to 2.0%, and more preferably 0.01 to 1.0%, with respect to the mordant mixture solution. The surfactant may be contained in the ink receiving layer forming liquid, as necessary.

Examples of the surfactants preferably used in the invention include nonionic surfactants and betaine type surfactants. The total content of the surfactant contained in the mordant mixture solution and the surfactant contained in the ink receiving layer coating liquid as necessary is preferably 0.01 to 0.5 g/m², more preferably 0.05 to 0.3 g/m². If the content of the surfactant is less than 0.01 g/m², wettability may be deteriorated. If the content of the surfactant is more than 0.5 g/m², the viscosity of coating may be increased.

In the invention, the ink receiving layer preferably contains a high boiling point organic solvent for preventing curling. The high boiling point organic solvent is an organic compound having a boiling point of 150° C. or higher at atmospheric pressure, and is a water-soluble or hydrophobic compound. The high boiling point organic solvent may be solid or liquid at room temperature, and may be a low molecular weight compound or a high molecular weight compound.

Examples of the organic solvent include aromatic carboxylic acid esters (such as dibutyl phthalate, diphenyl phthalate and phenyl benzoate); aliphatic carboxylic acid esters (such as dioctyl adipate, dibutyl sebacate, methyl stearate, dibutyl maleate, dibutyl fumarate and triethyl acetylcitrate); phosphoric acid esters (such as trioctyl phosphate and tricresil phosphate); epoxy compounds (such as epoxylated soy bean oil and epoxylated fatty acid methyl esters); alcohols (such as stearyl alcohol, ethyleneglycol, propyleneglycol, diethyleneglycol, triethyleneglycol, glycerin, diethyleneglycol monobutylether (DEGMBE), triethyleneglycol monobutylether, glycerin monomethylether, 1,2,3-butanetriol, 1,2,4-butanetriol, 1,2,4-pentanetriol, 1,2,6-hexanetriol, thiodiglycol, triethanolamine and polyethyleneglycol); vegetable oils (such as soy bean oil and sunflower oil); and higher aliphatic carboxylic acid (such as linoleic acid and oleic acid).

### Support

The support used in the invention may be a transparent support made of a transparent material such as plastics, or an opaque support made of an opaque material such as paper. A transparent support or a highly glossy opaque support is preferably used for taking advantage of transparency of the ink receiving layer. In an embodiment, the support is a read-only optical disk such as a CD-ROM or a DVD-ROM, a write-once optical disk such as a CD-R and a DVD-R, or a rewritable optical disk, and the ink receiving layer is provided on the labeling face side.

The material used for the transparent support is preferably transparent and resistant to radiant heat generated when used with an OHP or a backlight display. Examples of the material include polyesters such as polyethylene terephthalate (PET); polysulfone, polyphenylene oxide, polyimide, polycarbonate and polyamide. Polyesters are preferable, and polyethylene terephthalate is particularly preferable among them.

While the thickness of the transparent support is not particularly restricted, the thickness is preferably 50 to 200 μm from the viewpoint of ease of the handling.

The opaque support having high glossiness preferably has a surface with a glossiness of 40% or more on which the ink receiving layer is to be provided. The glossiness is measured according to the method (a 75 degree specular glossiness test method for paper sheets and paper board) defined in Japanese Industrial Standards (JIS) P-8142, which is incorporated herein by reference. Specific examples include the following supports.

Examples include highly glossy paper supports such as art paper, coat paper, cast-coat paper, and baryta paper used for silver salt photographic support; highly glossy films (which may have been subjected to a surface calendering treatment) comprising a plastic film that has been made opaque by adding a white pigment or the like, wherein the plastic film may be a polyester such as polyethylene terephthalate (PET), a cellulose ester such as nitrocellulose, cellulose acetate or cellulose acetate butylate, polysulfone, polyphenylene oxide, polyimide, polycarbonate or polyamide; and supports in which a coated layer of a polyolefin, which contains or does not contain a white pigment, on the surface of any of various paper supports as described above, a transparent support as described above, or a highly glossy film containing a white pigment or the like.

Foamed polyester films containing a white pigment (for example, foamed PET that contains polyolefin fine particles and voids formed by stretching) are also favorably used. Resin coat paper used for the silver salt photographic paper is also preferable.

While the thickness of the opaque support is not particularly restricted, it is preferably from 50 to 300 μm in consideration of ease of handling.

A corona discharge treatment, glow discharge treatment, flame treatment or UV irradiation treatment may be applied on the surface of the support for improving wettability and adhesive property.

The raw paper sheet used for the resin coat paper will be described in detail below.

The raw paper is produced using a wood pulp as a major material which may be added with a synthetic pulp such as polypropylene pulp, or synthetic fibers such as nylon or polyester fibers, as necessary. While any one of LBKP, LBSP, NBKP, NBSP, LDP, NDP, LUKP and NUKP may be used as the wood pulp, it is preferable to use a greater amount of LBKP, NBSP, LBSP, NDP and LDP, which contain a high proportion of short fibers, than other wood pulps.

However, the proportion of LBSP and/or LDP is preferably 10 mass % or more and 70 mass % or less.

Chemical pulps (such as sulfate pulp and sulfite pulp) containing little impurity may be preferably used, and a pulp whose brightness has been improved by a bleaching treatment is also useful.

The following agents may be added to the raw paper sheet as necessary: a sizing agent such as a higher fatty acid and alkylketene dimer; white pigment such as calcium carbonate, talc and titanium oxide; a paper strength enhancer such as starch, polyacrylamide and polyvinyl alcohol; a fluorescent brightener; a humectant such as polyethyleneglycol; a dispersing agent; a softening agent such as quaternary ammonium; and the like.

The freeness of the pulp to be used for paper-making is preferably from 200 to 500 ml as defined in CSF. Regarding the fiber length after beating, the sum of the percentage by mass of the 24 mesh filtration residue and the percentage by mass of the 42 mesh filtration residue is preferably 30 to 70 mass %. Such mesh filtration residues are defined in JIS P-8207, which is incorporated herein by reference. The percentage by mass of the 4 mesh filtration residue is preferably 20 mass % or less.

The basis weight of the raw paper is preferably from 30 to 250 g/m², particularly preferably from 50 to 200 g/m². The thickness of the raw paper is preferably from 40 to 250 μm. High smoothness can be rendered to the raw paper by applying a calender treatment during paper making or after paper making. The density of the raw paper is usually from 0.7 to 1.2 g/m³ (JIS P-8118, which is incorporated herein by reference).

The rigidity of the raw paper is preferably from 2 to 20 mN/m under the condition according to JIS P-8125, which is incorporated herein by reference.

The surface of the raw paper sheet may be coated with a surface sizing agent, which may be selected from the above-described examples of sizing agents that can be incorporated into the interior of the raw paper.

The pH of the raw paper is preferably from 5 to 9 when measured by a hot water extraction method according to JIS P-8113, which is incorporated herein by reference.

While polyethylene used for coating the front and back surfaces of the raw paper may contain, as a main component, a low density polyethylene (LDPE) and/or a high density polyethylene (HDPE). However, another LLDPE, polypropylene, and the like may also be used as a component.

The polyethylene layer on the side to be provided with the ink receiving layer is preferably obtained by adding titanium oxide of rutile or anatase type, fluorescent brightener and ultramarine blue to polyethylene such that opaqueness, whiteness, and hue are improved, as widely adopted in photographic paper. The content of titanium oxide relative to polyethylene is preferably from 3 to 20 mass %, more preferably from 4 to 13 mass %. While the thickness of the polyethylene layer is not particularly restricted, a thickness of 10 to 50 μm is favorable for both the layers on the front and back sides. An undercoat layer may be provided on the polyethylene layer so as to provide the polyethylene layer with adhesiveness to the ink receiving layer. Aqueous polyester, gelatin and PVA are preferable as the undercoat layer. The thickness of the undercoat layer is preferably from 0.01 to 5 μm.

The polyethylene coated paper may be used as glossy paper, or may be used as paper having such a matte surface or silky surface as realized in usual photographic paper if a so-called embossing treatment is conducted when polyethylene is coated on the surface of the raw paper by melt-extrusion.

A back coat layer may be provided on the support, and components that can be added to the back coat layer may be, for example, a white pigment, an aqueous binder and the like.

Examples of the white pigment contained in the back coat layer include inorganic white pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene-based plastic pigments, acrylic plastic pigments, polyethylene, microcapsules, urea resin and melamine resin.

Examples of the aqueous binder usable in the back coat layer include water-soluble polymers such as styrene/maleic acid salt copolymer, styrene/acrylic acid salt copolymer, polyvinyl alcohol, silanol-modified polyvinyl alcohol, starch, cationized starch, casein, gelatin, carboxymethyl cellulose, hydroxyethyl cellulose and polyvinyl pyrrolidone; and water dispersible polymers such as styrene-butadiene latex and acrylic emulsion.

Other components that can be contained in the back coat layer include defoaming agents, foaming suppressing agents, dyes, fluorescent brighteners, antiseptics and water-proofing agent.

A method for manufacturing an inkjet recording medium of the invention includes at least inline-mixing an ink receiving layer forming liquid containing inorganic fine particles and a water-soluble binder and a mordant mixture solution containing a basic poly aluminum hydroxide compound and a cationic polymer to form a coating liquid, and applying the coating liquid onto a support to form a coated layer. The method may further include applying a second liquid containing a basic compound onto the coated layer (1) simultaneously with the application of the first liquid, or (2) before the coated layer exhibits a decreasing rate of drying during drying of the coated layer formed by application of the first liquid, to crosslink and cure the coated layer to form an ink receiving layer.

It is preferred to provide the ink receiving layer thus crosslink-cured in view of ink absorbing property and prevention of film crack.

The inkr receiving layer coating liquid containing inorganic fine particles (e.g. gas phase silica) and a water-soluble binder (e.g. polyvinyl alcohol) can be prepared, for example, in the following manner.

Namely, inorganic fine particles such as gas phase silica and a dispersing agent are added to water (e.g. 10 to 20 mass % of silica fine particles in the water). The mixture is dispersed in a condition of high-speed rotation of, for example, 10000 rpm (preferably 5000 to 20000 rpm) for, for example, 20 minutes (preferably 10 to 30 minutes) by using a beads mill (for example, “KD-P” manufactured by Shima Enterprise Co., Ltd.). Thereafter, a polyvinyl alcohol (PVA) aqueous solution is added to the dispersion liquid. The amount of PVA is, for example, such an amount that the mass of PVA is one-third of the mass of the gas phase silica. The resulting mixture is dispersed in the same rotation condition as described above, whereby the coating liquid is obtained. It is preferred to adjust the pH of the coating liquid to around 9.2 with aqueous ammonia or the like, or to use a dispersing agent in order to render stability to the coating liquid. The resulting coating liquid is in a homogeneous sol state. When the coating liquid is applied onto a support by the following coating method, and is dried, a porous ink receiving layer having a three-dimensional network structure can be formed.

When the water dispersion containing the gas phase silica and the dispersing agent is prepared, a previously-prepared water dispersion of the gas phase silica may be added to an aqueous solution of the dispersing agent, or an aqueous solution of the dispersing agent may be added to a water dispersion of the gas phase silica, or they may be mixed simultaneously. As an alternative, powder of the gas phase silica may be added to the aqueous solution of the dispersing agent, instead of the water dispersion of the gas phase silica.

In an embodiment, after the gas phase silica and the dispersing agent are mixed, the mixture liquid is treated with a disperser, so that the particle size is reduced to give a water dispersion containing particles with an average particle diameter of 50 nm or less.

The solvent used in each process may be water, an organic solvent or a mixture of liquids selected from water and organic solvents. Organic solvents usable for coating include alcohols such as methanol, ethanol, n-propanol, i-propanol and methoxypropanol, ketones such as acetone and methylethyl ketone, tetrahydrofuran, acetonitrile, ethyl acetate and toluene.

A dispersing agent may be added for improving dispersibility of the coating liquid. The dispersing agent is not particularly limited, and may be a known cationic dispersing agent.

The amount of the dispersing agent to be added is preferably from 0.1 to 30%, more preferably from 1 to 10%, relative to the amount of the inorganic fine particles.

The pH of the first liquid is not particularly restricted, and is preferably from 2.0 to 6.0, more preferably from 3 to 5. Bleeding of image over time can be suppressed when the ink receiving layer is formed from the coating liquid having a pH of 2 to 6.

The first liquid can be applied by a known coating method using an extrusion die coater, an air doctor coater, a blade coater, a rod coater, a knife coater, a squeeze coater, a reverse roll coater or a bar coater.

The second liquid is applied onto the coated layer (i) simultaneously with the application of the first liquid, or (ii) before the coated layer exhibits a decreasing rate of drying during drying of the coated layer formed by the application of the first liquid. More specifically, the ink receiving layer is suitably manufactured by introducing the second liquid while the coated layer exhibits constant drying rate after the application of the first liquid. The second liquid may contain a mordant.

The second liquid may contain a crosslinking agent or other mordant components as necessary. When the second liquid is used in the form of an alkaline solution, hardening of the film can be promoted. The solution is preferably adjusted to have a pH of 7.1 or higher, more preferably 7.5 or higher, and particularly preferably 7.9 or higher. When the pH is too close to the acidic side, the crosslinking reaction of the water-soluble polymer contained in the first liquid caused by the crosslinking agent does not proceed sufficiently, so that there are cases where bronzing occurs or defects such as cracking occurs in the ink receiving layer.

The second liquid may be prepared, for example by adding a metal compound (e.g. 1 to 5%), a basic compound (e.g. 1 to 5%), and optionally paratoluenesulfonic acid (e.g. 0.5 to 3%) to ion-exchange water, and agitating the resultant mixture solution sufficiently. The “%” values for the respective components each mean a mass % of the solid content.

The expression “before the coated layer exhibits a decreasing rate of drying” usually refers to a process within a few minutes from immediately after the application of the coating liquid, during which a phenomenon, “constant drying rate”, is observed. The constant drying rate refers to a proportional decrease in content of the solvent (dispersion medium) in the coated layer to time. The time during which the “constant drying rate” is observed is described, for example, in “Kagaku Kogaku Binran (Handbook of Chemical Engineering) (pages 707 to 712, published from Maruzen Co., Ltd. on October 25, 1980).

As described above, the coated layer is dried after the first liquid is applied until the coated layer exhibits a constant rate of drying. In general, the drying is carried out at 40 to 180° C. for 0.5 to 10 minutes (preferably 0.5 to 5 minutes). The drying time naturally differs depending on the amount of the coating liquid to be applied, but the above range is usually preferable.

### EXAMPLES

In the following, the present invention is specifically described by reference to Examples. However, the Examples should not be construed as limiting the invention.

### Example 1

### Preparation of Support

Pulp slurry was prepared by beating 50 parts of LBKP made of acacia and 50 parts of LBKP made of aspen with a disk free refiner to a Canadian Freeness of 300 ml.

Then, 1.3% of a cationic starch (trade name: CATO 304L, manufactured by Japan NSC Corporation), 0.15% of anionic polyacrylamide (trade name: DA4104, manufactured by Seiko PMC Corporation), 0.29% of an alkylketen dimer (trade name: SIZEPINE K, manufactured by Arakawa Chemical Industries, Ltd.), 0.29% of epoxylated behenic acid amide, and 0.32% of polyamide polyamine epichlorohydrin (trade name: ARAFIX 100, manufactured by Arakawa Chemical Industries, Ltd.) per pulp were added to the resulting pulp slurry, and then 0.12% of antifoaming agent was added thereto.

The pulp slurry prepared as described above was used for papermaking with a fourdrinier. The felt face of the resulting web was pushed forcibly to a drum dryer cylinder by a dryer canvas so as to be dried. During the drying, the tensile force of the dryer canvas was set at 1.6 kg/cm. Then, 1 g/m² of polyvinyl alcohol (trade name: KL-1 18, manufactured by Kuraray Co., Ltd.) was applied onto both sides of the raw paper with a size press, followed by drying. Then, a calendering treatment was carried out. The basis weight of the raw paper was 166 g/m², and the obtained raw paper (base paper) had a thickness of 160 μm.

The wire face (rear side) of the resultant base paper was subjected to corona discharge treatment. Thereafter, high-density polyethylene was applied onto the wire face to a thickness of 25 μm with a melt extruder to form a thermoplastic resin layer constituting a matte surface (hereinafter the surface of the thermoplastic resin layer is referred to as “backside”). The thermoplastic resin layer on the backside was further subjected to a corona discharge treatment; and then a dispersion liquid containing aluminum oxide (trade name: ALUMINASOL 100, manufactured by Nissan Chemical Industries, Co., Ltd.) and silicate dioxide (trade name: SNOWTEX O, manufactured by Nissan Chemical Industries, Co., Ltd.) as antistatic agents in a mass ratio of 1:2 dispersed in water was applied to give a dry mass of 0.2 g/m², whereby a support was obtained.

The felt face (surface) having no thermoplastic resin layer was then corona-discharged; low-density polyethylene having an MFR (melt flow rate) of 3.8 containing 10% of anatase titanium dioxide, 0.3% of ultramarine manufactured by Tokyo Printing Ink Mfg. Co., and 0.08% of a fluorescent brightener “Whiteflour PSN conc” manufactured by Nippon Chemical Works Co., Ltd. was coated thereon by using a melt extruder to a thickness of 25 μm, forming a high-gloss thermoplastic resin layer on the surface of the base paper (hereinafter, the side having the high-gloss surface will be referred to as “front side”), to give a support. The support was wound into a continuous roll having a width of 1.5 m and a winding length of 3,000 m.

### Preparation of Ink Receiving Layer Forming Liquid

(1) Gas phase silica fine particles, (2) ion-exchange water, (3) “Sharol DC-902P”, and (4) “ZA-30” in the following composition were mixed, and the mixture was dispersed with a beads mill (for example, KD-P manufactured by Shinmaru Enterprises Corporation). Then, the dispersion liquid was heated to 45° C. and kept at the temperature for 20 hours. Thereafter, the following (5) boric acid, (6) polyvinyl alcohol solution, (7) “SUPERFLEX 600”, (8) compound A, and (9) ethanol were added to the dispersion liquid at 30° C., so that an ink receiving layer forming liquid was prepared.

The mass ratio of the silica fine particles to the water-soluble binder (PB ratio=(1): (6)) was 4.45:1, and the pH of the ink receiving layer forming liquid was 3.8, which was acidic.

### <Composition of Ink Receiving Layer Forming Liquid>

| | |
|---|---|
| (1) Gas phase silica fine particles (inorganic fine particles) | 8.9 parts |
| (trade name: AEROSIL 300SF75, manufactured by Nippon | |
| Aerosil Co., Ltd.) | |
| (2) Ion-exchange water | 51.4 parts |
| (3) “SHAROL DC-902P” (51.5% aqueous solution) | 0.78 part |
| (Dispersing agent, manufactured by Dai-ichi Kogyo | |
| Seiyaku Co., Ltd.) | |
| (4) “ZA-30” | 0.48 part |
| (manufactured by Daiichi Kigenso Kagakukogyo Co., Ltd.) | |
| (5) Boric acid (crosslinking agent) | 0.33 part |
| (6) Polyvinyl alcohol (water-soluble binder) solution | 28.6 parts |
| (Composition of the solution: | |
| “PVA235” manufactured by Kraray Co., Ltd., with a | 2.0 parts |
| saponification degree of 88% and a polymerization degree | |
| of 3500 | |
| Ion-exchange water | 26.6 parts) |
| (7) “SUPERFLEX 600” | 1.11 parts |
| (manufactured by Dai-ichi Kogyo Seiyaku Co., Ltd.) | |
| (8) Compound A | 0.66 part |
| 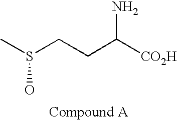 | |
| (9) Ethanol | 4.1 parts |

### Production of Inkjet Recording Medium

The front surface of the support was subjected to corona discharge treatment. Then, 173 cc/M² of the ink receiving layer forming liquid and 10.8 ml/m² of the following mordant mixture solution were coated on the front surface of the support (coating process) while they were mixed to form a coating liquid (the first liquid). Then, drying was conducted at 80° C. (at a wind velocity of 3 to 8 m/sec) in a hot-air dryer until the solid concentration of the coated layer became 24%. The coated layer exhibited a constant drying rate in this period. Immediately thereafter, the support was immersed in the second coating liquid having the following composition for 3 seconds, so that 13 g/m² of the second coating liquid adhered to the coated layer (process of applying a mordant solution). Then, drying was further conducted at 72° C. for 10 minutes (drying process). As a result, an inkjet recording medium according to the invention having an ink receiving layer whose dry film thickness was 32 μm was obtained.

### <Composition of Mordant Mixture Solution>

| | |
|---|---|
| (1) Basic poly aluminum hydroxide compound | 4.0 parts |
| (trade name: ALUFINE 83, | |
| manufactured by Taimei Chemicals Co., Ltd) | |
| (2) Ion-exchange water | 4.6 parts |
| (3) Polyoxyethylene laurylether (surfactant) | 0.7 parts |
| (trade name: “EMULGEN 109P”, manufactured by | |
| Kao Corporation; (10% aqueous | |
| solution), HLB value: 13.6) | |
| (4) Cation polymer | 0.7 parts |
| (trade name: “HIMAX SC-505”, manufactured by Hymo | |
| Co., Ltd. | |

### <Composition of Second Liquid>

| | |
|---|---|
| (1) Boric acid | 0.65 part |
| (2) Ammonium carbonate | 4.0 parts |
| (Primary: Kanto Chemical co., Inc.) | |
| (4) Ion-exchange water | 89.4 parts |
| (5) Polyoxyethylene laurylether (surfactant) | 6.0 parts |
| (trade name: “EMULGEN 109P”, manufactured by Kao | |
| Corporation; (10% aqueous | |
| solution), HLB value: 13.6) | |

### Example 2

An inkjet recording medium was produced in the same manner as in Example 1 except that 10% polyoxyethylene laurylether aqueous solution (EMULGEN 109P) in the mordant mixture solution was replaced by ion-exchange water, and that 0.44 parts of 10% polyoxyethylene laurylether aqueous solution (EMULGEN 109P) was added to the ink receiving layer forming liquid.

### Example 3

An inkjet recording medium was produced in the same manner as in Example 1 except that 10% polyoxyethylene laurylether aqueous solution (EMULGEN 109P) in the mordant mixture solution was replaced by 10% lauryl dimethylamino acetic acid betaine aqueous solution.

### Example 4

An inkjet recording medium was produced in the same manner as in Example 1 except that SUPERFLEX 600 in the ink receiving layer forming liquid was replaced by ion-exchange water.

### Comparative Example 1

An inkjet recording medium was produced in the same manner as in Example 1 except that HIMAX SC-505 in the mordant mixture solution was replaced by ion-exchange water.

### Comparative Example 2

An inkjet recording medium was produced in the same manner as in Example 1 except that HIMAX SC-505 in the mordant mixture solution was replaced by ion-exchange water and that 0.46 parts of HIMAX SC-505 was added to the ink receiving layer forming liquid.

### Comparative Example 3

An inkjet recording medium was produced in the same manner as in Comparative Example 2 except that 10% polyoxyethylene laurylether aqueous solution (EMULGEN 109P) in the mordant mixture solution was replaced by ion-exchange water, and that 0.44 parts of 10% polyoxyethylene laurylether aqueous solution (EMULGEN 109P) was added to the ink receiving layer forming liquid.

### Example 5

An inkjet recording medium was produced in the same manner as in Example 1 except that HIMAX SC-505 in the mordant mixture solution was replaced by a homopolymer of trimethyl-2-(methacryloyloxy) ethyl ammonium chloride.

The ink-jet recording media thus obtained were evaluated in the following tests. The results obtained are summarized in Table 1.

### Evaluation of Change in Viscosity of Ink Receiving Layer Forming Liquid over Time

The ink receiving layer-forming liquid five days after adjustment was analyzed by using a Type-B viscometer and evaluated according to the following criteria:

A: 150 mPa·S or less

B: more than 150 mPa·S and less than 300 mPa·S

C: 300 mPa·S or more

### Evaluation of Coated Surface Property

Surface cracking on each ink-jet recording medium surface after formation of an ink receiving layer was evaluated by visual observation according to the following criteria:

A: No cracking

B: Some cracking observed, although only slightly

C: Many cracks observed

### Evaluation of Ozone Resistance

A solid cyan-colored image was printed on each recording medium in an inkjet printer containing a standard ink set (“PMG-800”, manufactured by Seiko Epson Corporation), and the printed sample was stored in an environment at 23° C., 60% RH, and an ozone concentration of 10 ppm for 48 hours. The cyan density was determined by using a reflection densitometer (X RITE 938, manufactured by Xrite), and the color residual ratio was determined from the cyan densities before and after storage according to the following Formula and evaluated according to the following criteria:

Residual ratio (%)=(cyan density after storage/cyan density before storage)×100

A: 65% or more

B: more than 55% and less than 65%

C: 55% or less

### Evaluation of Ink Bleeding

A gray image was printed on each ink-jet recording medium in an inkjet printer (PIXUS990i, manufactured by Canon Inc.). The printed ink-jet recording medium was inserted into a transparent PP file after printing and stored in an environment at 35° C. and a relative humidity of 80% for three days. Then, the color change in the gray image was evaluated by visual observation according to the following criteria:

A: No significant change observed

B: Some color change observed

C: Significant color change observed

TABLE 1

| | | | | | | Comparative | Comparative | Comparative | |
|---|---|---|---|---|---|---|---|---|---|
| | | Example 1 | Example 2 | Example 3 | Example 4 | Example 1 | Example 2 | Example 3 | Example 5 |
| Mordant | Basic | Yes | Yes | Yes | Yes | Yes | Yes | Yes | Yes |
| mixture | polyaluminum | | | | | | | | |
| liquid | hydroxide | | | | | | | | |
| | Cationic | SC-505 | SC-505 | SC-505 | SC-505 | No | No | No | (I/O = 3.5) |
| | polymer | (I/O = 5) | (I/O = 5) | (I/O = 5) | (I/O = 5) | | | | |
| | Surfactant | EMULGEN | No | Betaine | EMULGEN | EMULGEN | EMULGEN | No | EMULGEN |
| | | 109P | | | 109P | 109P | 109P | | 109P |
| Ink | Cationic | No | No | No | No | No | SC-505 | SC-505 | No |
| receiving | polymer | | | | | | | | |
| layer- | EMULGEN | No | Yes | No | No | No | No | Yes | No |
| forming | 109P | | | | | | | | |
| liquid | SUPERFLEX | Yes | Yes | Yes | No | Yes | Yes | Yes | Yes |
| | 600 | | | | | | | | |

| | | | | | | | | |
|---|---|---|---|---|---|---|---|---|
| Viscosity | A | A | A | A | A | C | C | A |
| Coated surface property | A | B | A | A | A | A | B | A |
| Ozone resistance | A | A | A | A | C | A | A | B |
| Ink bleeding | A | A | A | B | A | A | A | A |

As apparent from Table 1, it is possible to produce an ink-jet recording medium superior in ozone resistance and coated surface property, by in-line mixing of a cationic polymer having a higher I/O value with basic polyaluminum oxide.

According to the invention, a method for manufacturing an inkjet recording medium, which is capable of suppressing an increase in the viscosity of the coating liquid, and an ink jet recording medium manufactured by the method, which has excellent ozone resistance, can be provided.

In the following, exemplary embodiments of the invention will be described. However, the present invention is not limited to the following embodiments.

<1> A method for manufacturing an inkjet recording medium comprising at least:

inline-mixing an ink receiving layer forming liquid containing inorganic fine particles and a water-soluble binder and a mordant mixture solution containing a basic poly aluminum hydroxide compound and a cationic polymer to form a coating liquid; and

applying the coating liquid onto a support to form a coated layer.

<2> The method for manufacturing an inkjet recording medium as described in <1>, wherein the cationic polymer has an I/O value of 3 or more.

<3> The method for manufacturing an inkjet recording medium as described in <1>, wherein the mordant mixture solution further contains a surfactant.

<4> The method for manufacturing an inkjet recording medium as described in <3>, wherein a content of the surfactant is 0.001 to 2.0 mass % relative to the mordant mixture solution.

<5> The method for manufacturing an inkjet recording medium as described in <1>, wherein at least one of the ink receiving layer forming liquid or the mordant mixture solution further contains a water-dispersible latex.

<6> The method for manufacturing an inkjet recording medium as described in <1>, wherein at least one of the ink receiving layer forming liquid or the mordant mixture solution further contains a crosslinking agent.

<7> The method for manufacturing an inkjet recording medium as described in <1>, wherein the water-soluble binder is a polyvinyl alcohol resin.

<8> The method for manufacturing an inkjet recording medium as described in <6>, wherein the crosslinking agent is boric acid.

<9> The method for manufacturing an inkjet recording medium as described in <1>, further comprising applying a basic solution containing a basic compound onto the coated layer (1) simultaneously with the application of the coating liquid, or (2) before the coated layer exhibits a decreasing rate of drying during drying of the coated layer formed by the application of the coating liquid, to crosslink and cure the coated layer to form an ink receiving layer.

<10> The method for manufacturing an inkjet recording medium as described in <1>, wherein the fine particles are selected from the group consisting of silica fine particles, colloidal silica, alumina fine particles and pseudo-boehmite.

<11> The method for manufacturing an inkjet recording medium as described in <1>, wherein a content of the water-soluble binder is 9 to 40 mass % relative to a mass of the total solid content of the ink receiving layer.

<12> The method for manufacturing an inkjet recording medium as described in <1>, wherein the cationic polymer is a polyalkylamine epichlorohydrin polycondensate.

<13> The method for manufacturing an inkjet recording medium as described in <1>, wherein a content of the cationic polymer in the ink receiving layer is 0.01 to 2.0 g/m².

<14> An inkjet recording medium manufactured by the method for manufacturing an inkjet recording medium as described in <1>.

All publications, patent applications, and technical standards mentioned in this specification are herein incorporated by reference to the same extent as if each individual publication, patent application, or technical standard was specifically and individually indicated to be incorporated by reference.

What is claimed is:

1. A method for manufacturing an inkjet recording medium comprising at least:
inline-mixing an ink receiving layer forming liquid containing inorganic fine particles and a water-soluble binder and a mordant mixture solution containing a basic poly aluminum hydroxide compound and a cationic polymer to form a coating liquid; and
applying the coating liquid onto a support to form a coated layer.

2. The method for manufacturing an inkjet recording medium according to claim 1, wherein the cationic polymer has an I/O value of 3 or more.

3. The method for manufacturing an inkjet recording medium according to claim 1, wherein the mordant mixture solution further contains a surfactant.

4. The method for manufacturing an inkjet recording medium according to claim 3, wherein a content of the surfactant is 0.001 to 2.0 mass % relative to the mordant mixture solution.

5. The method for manufacturing an inkjet recording medium according to claim 1, wherein at least one of the ink receiving layer forming liquid or the mordant mixture solution further contains a water-dispersible latex.

6. The method for manufacturing an inkjet recording medium according to claim 1, wherein at least one of the ink receiving layer forming liquid or the mordant mixture solution further contains a crosslinking agent.

7. The method for manufacturing an inkjet recording medium according to claim 1, wherein the water-soluble binder is a polyvinyl alcohol resin.

8. The method for manufacturing an inkjet recording medium according to claim 6, wherein the crosslinking agent is boric acid.

9. The method for manufacturing an inkjet recording medium according to claim 1, further comprising applying a basic solution containing a basic compound onto the coated layer (1) simultaneously with the application of the coating liquid, or (2) before the coated layer exhibits a decreasing rate of drying during drying of the coated layer formed by the application of the coating liquid, to crosslink and cure the coated layer to form an ink receiving layer.

10. The method for manufacturing an inkjet recording medium according to claim 1, wherein the fine particles are selected from the group consisting of silica fine particles, colloidal silica, alumina fine particles and pseudo-boehmite.

11. The method for manufacturing an inkjet recording medium according to claim 1, wherein a content of the water-soluble binder is 9 to 40 mass % relative to a mass of the total solid content of the ink receiving layer.

12. The method for manufacturing an inkjet recording medium according to claim 1, wherein the cationic polymer is a polyalkylamine epichlorohydrin polycondensate.

13. The method for manufacturing an inkjet recording medium according to claim 1, wherein a content of the cationic polymer in the ink receiving layer is 0.01 to 2.0 g/m².

14. An inkjet recording medium manufactured by the method for manufacturing an inkjet recording medium according to claim 1.
